(19) United States
(12) Patent Application Publication
(10) Pub. No.: US 2019/0390781 A1
(43) Pub. Date: Dec. 26, 2019

(54) CONTROL VALVE

(71) Applicant: YAMADA MANUFACTURING CO., LTD., kiryu-shi, Gunma (JP)

(72) Inventor: Akifumi Ozeki, Kiryu-shi (JP)

(21) Appl. No.: 16/481,225

(22) PCT Filed: Mar. 16, 2018
(86) PCT No.: PCT/JP2018/010561

§ 371 Date: Jul. 26, 2019

(30) Foreign Application Priority Data
Mar. 17, 2017 (JP) 2017-053684

(51) Int. Cl. F16K 11/076; F16K 25/00

(52) U.S. Cl. CPC F16K 11/076; F16K 25/00

(57) ABSTRACT

A control valve includes a valve housing, a joint member, a valve body, and a sealing tubular member. The joint member and the sealing tubular member are provided with first facing portions that face each other in an axial direction of the sealing tubular member and second facing portions that face each other in the axial direction while being disposed inward of the first facing portions in a radial direction of the sealing tubular member. The second facing portions are provided with an urging spring that is interposed between the joint member and the sealing tubular member and that urges the sealing tubular member toward the valve body.

### TECHNICAL FIELD

The present invention relates to a control valve that is used for switching between flow paths for vehicle cooling water or the like. Priority is claimed on Japanese Patent Application No. 2017-053684, filed on Mar. 17, 2017, the content of which is incorporated herein by reference.

### BACKGROUND ART

In a cooling system in which an engine is cooled by means of cooling water, a bypass flow path, a warming flow path, or the like may be additionally provided separately from a radiator flow path for circulation between a radiator and the engine. The bypass flow path is a flow path that bypasses the radiator. The warming flow path is a flow path that passes through an oil warmer. In such a cooling system, a control valve is provided at a junction between flow paths. In the cooling system, the control valve switches between the flow paths. As the control valve, a control valve in which a valve body provided with a cylindrical wall is rotatably disposed in a valve housing is known (refer to Patent Document 1). The control valve described in Patent Document 1 opens and closes a random flow path corresponding to a rotation position of the valve body.

In the control valve described in Patent Document 1, the valve housing is provided with an inflow port through which liquid such as cooling water flows into the valve housing and a set number of discharge ports through which the liquid flowing into the valve housing is discharged to the outside. A plurality of valve holes through which the inside and the outside of the cylindrical wall communicate with each other are formed in the cylindrical wall of the valve body to respectively correspond to the discharge ports. A joint member for connecting a discharge side pipe is bonded to a circumferential edge of each of the discharge ports of the valve housing. A first side end portion of a sealing tubular member is slidably held at a portion of each joint member that is inside the valve housing. A second side of each sealing tubular member is provided with a valve slide contact surface. The slide contact surface of each sealing tubular member is in slide contact with an outer surface of the cylindrical wall at a position at which at least a portion thereof overlaps a rotation route of a corresponding valve hole of the valve body.

When the valve body is at a rotation position at which the sealing tubular member communicates with a corresponding valve hole, the valve body allows liquid to flow out to a corresponding discharge port from a region inside the cylindrical wall. When the valve body is at a rotation position at which the sealing tubular member does not communicate with the corresponding valve hole, the valve body blocks the liquid flowing out to the corresponding discharge port from the region inside the cylindrical wall. Note that, the rotation position of the valve body is managed by an actuator (electric motor or like).

In the control valve described in Patent Document 1, the sealing tubular member is urged toward the valve body by an urging spring. Therefore, the pressure of liquid in the valve housing and an urging force of the spring act on the sealing tubular member.

Specifically, the sealing tubular member is slidably mounted on an outer circumferential surface of a tubular portion that protrudes at an inner end of the joint member. A space between the outer circumferential surface of the tubular portion and an inner circumferential surface of the sealing tubular member is tightly closed by a seal ring. The urging spring is interposed between an end surface of the sealing tubular member that is separate from the valve body and the joint member. A region on the sealing tubular member that is separate from the valve body (spring supporting region and seal ring holding region) is a first surface of action on which the pressure of liquid in the valve housing acts in a direction in which the sealing tubular member is pressed against the valve body. An outer circumferential edge portion of the valve slide contact surface of the sealing tubular member is provided with a second surface of action which has an annular shape and on which the pressure of liquid in the valve housing acts in a direction in which the sealing tubular member is separated from the valve body. The area of the first surface of action is set to be larger than the area of the second surface of action. A force corresponding to a difference between the area of the first surface of action and the area of the second surface of action and the pressure of liquid acts on the sealing tubular member as a pressing force toward the valve body.

### CITATION LIST

### Patent Literature

[Patent Document 1] Japanese Unexamined Patent Application, First Publication No. 2015-218763

### SUMMARY OF INVENTION

### Technical Problem

In the control valve described in Patent Document 1, an inner circumferential portion of the sealing tubular member is provided with the seal ring holding region. The spring supporting region is disposed outward of the seal ring holding region (at position on end surface of sealing tubular member close to radially outer side). Therefore, a pressing load generated by the urging spring is likely to act on a radially outer position on the valve slide contact surface of the sealing tubular member.

Meanwhile, in the control valve in which the valve slide contact surface of the sealing tubular member abuts the outer surface of the cylindrical wall of the valve body, it is necessary to allow the cylindrical wall to slide with respect to the valve slide contact surface. A slight gap is formed between the valve slide contact surface and the outer surface of the cylindrical wall. Therefore, the pressing load generated by the urging spring is important in maintaining a sealing performance of the end portion of the sealing tubular member for a long period of time.

However, the control valve described in Patent Document 1 has a structure in which the pressing load generated by the urging spring acts on a radially outer side of the valve slide contact surface of the sealing tubular member. Therefore, when wear of the valve slide contact surface of the sealing tubular member progresses from the radially outer side, it may be difficult to maintain a sealed state at a valve slide contact portion.

The present invention provides a control valve with which it is possible to maintain a high sealing performance of a valve slide contact surface of a sealing tubular member for a long period of time.

### Solution to Problem

According to a first aspect of the present invention, there is provided a control valve including a valve housing that is provided with an inflow port through which liquid flows into the valve housing from an outside and a discharge port through which the liquid flowing into the valve housing is discharged to the outside, a joint member connected to the discharge port, a valve body that is rotatably disposed in the valve housing and is provided with a hollow rotary body in which a valve hole, through which an inside and an outside of the hollow rotary body communicate with each other, is formed, and a sealing tubular member that is provided with a valve slide contact surface, which slidably abuts an outer surface of the hollow rotary body at a position at which at least a portion of the valve slide contact surface overlaps a rotation route of the valve hole of the valve body, and that connects the joint member and the valve body to each other inside the discharge port. The valve body allows liquid to flow out to the discharge port from a region inside the hollow rotary body when the valve body is at a rotation position at which the valve hole and the sealing tubular member communicate with each other and the valve body controls or blocks the liquid flowing out to the discharge port from the region inside the hollow rotary body when the valve body is at a rotation position at which the valve hole and the sealing tubular member do not communicate with each other. The joint member is provided with a tubular portion that is disposed inward of the sealing tubular member and slidably holds an inner circumferential surface of the sealing tubular member via a seal ring. The joint member and the sealing tubular member are provided with first facing portions that face each other in an axial direction of the sealing tubular member, and second facing portions that face each other in the axial direction while being disposed inward of the first facing portions in a radial direction of the sealing tubular member. The second facing portions are provided with an urging spring that is interposed between the joint member and the sealing tubular member and that urges the sealing tubular member toward the valve body.

According to the above-described configuration, the load of the urging spring acts on the second facing portions positioned radially inward of the first facing portions. Accordingly, the valve slide contact surface of the sealing tubular member is pressed against the outer surface of the hollow rotary body of the valve body by the urging spring at a position close to a radially inner side of the sealing tubular member. Accordingly, even in a case where wear of the valve slide contact surface progresses from the radially outer side with the valve slide contact surface used for a period of time, a radially inner region of the valve slide contact surface can be reliably brought into press contact with the outer surface of the hollow rotary body while receiving the load of the urging spring.

In the control valve according to a second aspect of the present invention, a surface of the sealing tubular member, which faces the joint member and which is one of the first facing portions, may constitute a pressure receiving urging surface that receives a pressure of liquid in the valve housing and generates a pressing force in a direction toward the valve body and an area of the valve slide contact surface may be set to be larger than an area of the pressure receiving urging surface.

In this case, it is possible to maintain the sealing performance of the sealing tubular member at all times and to suppress the valve slide contact surface being pressed against the outer surface of the hollow rotary body of the valve body with an excessive force even in a case where the pressure of liquid in the valve housing is increased.

In the control valve according to a third aspect of the present invention, the tubular portion may be provided with a small-diameter outer circumferential surface, a large-diameter outer circumferential surface that is formed to be increased in diameter in a stepped shape from an end portion of the small-diameter outer circumferential surface that is separate from the valve body, and a level difference surface that connects the small-diameter outer circumferential surface and the large-diameter outer circumferential surface to each other, the sealing tubular member may be provided with a medium-diameter inner circumferential surface that is slidably fitted onto the small-diameter outer circumferential surface of the joint member, a large-diameter inner circumferential surface that is formed to be increased in diameter in a stepped shape from an end portion of the medium-diameter inner circumferential surface that is separate from the valve body, a first connection surface that connects the medium-diameter inner circumferential surface and the large-diameter inner circumferential surface to each other, a small-diameter inner circumferential surface that is formed to be decreased in diameter in a stepped shape from an end portion of the medium-diameter inner circumferential surface that is close to the valve body, and a second connection surface that connects the medium-diameter inner circumferential surface and the small-diameter inner circumferential surface to each other, an annular seal accommodation space surrounded by the small-diameter outer circumferential surface and the large-diameter inner circumferential surface may be provided between the level difference surface of the joint member and the first connection surface of the sealing tubular member, the seal ring may be in close contact with the small-diameter outer circumferential surface and the large-diameter inner circumferential surface inside the seal accommodation space, and the urging spring may be interposed between the second connection surface and the tubular portion in the second facing portions.

In this case, the liquid pressure acts on the seal ring through a gap between the small-diameter outer circumferential surface and the large-diameter inner circumferential surface. Accordingly, the seal ring presses the sealing tubular member toward the valve body via the first connection surface. That is, surfaces of the seal ring and the sealing tubular member that face a side opposite to the valve body side in the axial direction constitute the pressure receiving urging surface. Accordingly, it is easy to secure the area of the pressure receiving urging surface while securing the sealing properties between the tubular portion and the sealing tubular member.

In the control valve according to a fourth aspect of the present invention, a liquid pressure chamber into which a pressure of liquid in the valve housing is introduced may be formed between the level difference surface of the joint member and the seal ring and a closeness prevention groove through which the liquid pressure chamber and an outside of the liquid pressure chamber communicate with each other may be formed in the level difference surface of the joint member.

In this case, even if the seal ring is pressed against the level difference surface with a large force, it is possible to prevent the seal ring from remaining fixed onto the level difference surface by means of the closeness prevention groove. That is, even in a case where the seal ring is pressed against the level difference surface with a large force, the inside of the liquid pressure chamber communicates with the outside through the closeness prevention groove and thus the inside of the liquid pressure chamber does not enter a state in which liquid in the valve housing cannot be introduced thereto. Accordingly, it is possible to prevent a pressure receiving area in a valve body pressing direction on the sealing tubular member side from being substantially decreased with the seal ring fixed onto the level difference surface. As a result, when adopting this configuration, it is possible to maintain the sealing performance of the sealing tubular member.

In the control valve according to a fifth aspect of the present invention, an annular accommodation groove in which the seal ring is accommodated may be formed in an outer circumferential surface of the tubular portion.

In this case, it is possible to install the joint member to the discharge port in a state where the seal ring is held in the accommodation groove. Accordingly, it is possible to achieve simplification of the configuration and an improvement in installing properties.

In the present embodiment, the seal ring is in contact with the sealing tubular member only in the radial direction (is not in contact with sealing tubular member in axial direction) at a position between the first facing portions and the second facing portions. However, the liquid pressure acts on the seal ring through a gap between the tubular portion and the sealing tubular member. Accordingly, the frictional resistance between the sealing tubular member and the seal ring can be increased with the seal ring crushed in the axial direction.

In the control valve according to a sixth aspect of the present invention, a restriction portion that protrudes in the axial direction from at least one of the joint member and the sealing tubular member and that holds the urging spring in the radial direction is formed in a portion of the second facing portions that is positioned radially inward of the urging spring.

In this case, it is possible to restrict the urging spring from positionally deviating relative at least one of the joint member and the sealing tubular member in the radial direction by means of the restriction portion and to suppress turbulence of liquid flowing inside the sealing tubular member by means of the restriction portion.

### Advantageous Effects of Invention

According to the control valve, the valve slide contact surface of the sealing tubular member is pressed against the outer surface of the hollow rotary body of the valve body by the urging spring at a position close to the radially inner side of the sealing tubular member. Accordingly, even in a case where wear of the valve slide contact surface progresses from the radially outer side with the valve slide contact surface used for a period of time, a radially inner region of the valve slide contact surface can be reliably brought into press contact with the outer surface of the hollow rotary body by means of the urging spring. Therefore, in a case where the present invention is adopted, it is possible to maintain a high sealing performance of the valve slide contact surface of the sealing tubular member for a long period of time.

### BRIEF DESCRIPTION OF DRAWINGS

FIG. 1 is a block diagram of a cooling system according to a first embodiment.

FIG. 2 is a perspective view of a control valve according to the first embodiment.

FIG. 3 is an exploded perspective view of the control valve according to the first embodiment.

FIG. 4 is a sectional view taken along line IV-IV in FIG. 2.

FIG. 5 is an enlarged view of part V in FIG. 4.

FIG. 6 is a perspective view of a portion of a joint member of the control valve according to the first embodiment.

FIG. 7 is a graph showing the result of a test with respect to a control valve according to an embodiment and control valves according to comparative examples.

FIG. 8 is a sectional view similar to FIG. 4 and shows a modification example of the control valve according to the first embodiment.

FIG. 9 is a sectional view similar to FIG. 4 and shows another modification example of the control valve according to the first embodiment.

FIG. 10 is a sectional view corresponding to FIG. 4 and shows a control valve according to a second embodiment.

FIG. 11 is a sectional view corresponding to FIG. 4 and shows a control valve according to a third embodiment.

FIG. 12 is a sectional view corresponding to FIG. 4 and shows a control valve according to a modification example of the embodiment.

### DESCRIPTION OF EMBODIMENTS

Hereinafter, an embodiment of the present invention will be described based on drawings. Hereinafter, a case where a control valve according to the present embodiment is applied to a vehicle cooling system in which an engine is cooled by means of cooling water will be described.

### First Embodiment

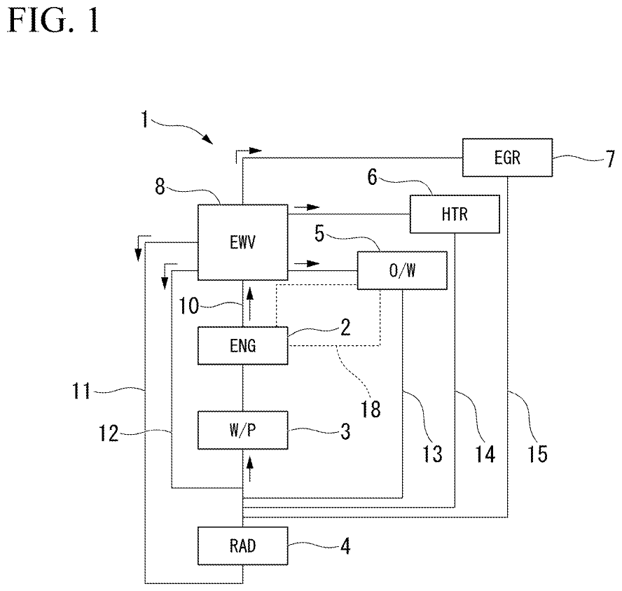

FIG. 1 is a block diagram of a cooling system 1.

As shown in FIG. 1, the cooling system 1 is installed in vehicle that is provided with at least an engine 2 as a vehicle drive source. Note that, the vehicle may be a hybrid vehicle, a plug-in hybrid vehicle, or the like instead of a vehicle including the engine 2 only.

The cooling system 1 is configured such that the engine 2 (ENG), a water pump 3 (W/P), a radiator 4 (RAD), an oil warmer 5 (0/W), a heater core 6 (HTR), an EGR cooler 7 (EGR), and a control valve 8 (EWV) are connected to one another via various flow paths 10 to 15.

An inlet side of a cooling path in the engine 2 is connected to a discharge side of the water pump 3. The control valve 8 is connected to an outlet side of the cooling path in the engine 2. A cooling flow path that connects the water pump 3, the engine 2, and the control valve 8 to each other in order from upstream to downstream constitutes the main flow path 10 in the cooling system 1.

The main flow path 10 divides into the radiator flow path 11, the bypass flow path 12, the warming flow path 13, the air conditioning flow path 14, and the EGR flow path 15, in the control valve 8. A downstream side of each of the radiator flow path 11, the bypass flow path 12, the warming flow path 13, the air conditioning flow path 14, and the EGR flow path 15 is connected to an intake side of the water pump 3.

The radiator 4 is provided at the radiator flow path 11. The radiator 4 performs heat exchange between cooling water flowing through the radiator flow path 11 and the outside air. The cooling water cooled when passing through the radiator 4 is returned to the intake side of the water pump 3 (to main flow path 10).

The bypass flow path 12 is a flow path that bypasses the radiator 4 at a time when the temperature of cooling water is low or the like. In the bypass flow path 12, the cooling water is returned to the intake side of the water pump 3 (to main flow path 10) as it is.

The oil warmer 5 (heat exchanger for engine oil) is provided at the warming flow path 13. The oil flow path 18 is connected to the oil warmer 5. Engine oil circulating in the engine 2 flows through the oil flow path 18. In the oil warmer 5, heat exchange between cooling water flowing through the warming flow path 13 and the engine oil is performed. Note that, in the present embodiment, in the viewpoint of fuel efficiency improvement or early stage warming, a heat exchanger is used as the “oil warmer 5”. However, although depending on operating conditions, the temperature of the cooling water may become higher than the temperature of the engine oil. In this case, it is a matter of course that the heat exchanger is used as an “oil cooler”.

The heater core 6 is provided at the air conditioning flow path 14. The heater core 6 is provided in, for example, a duct (not shown) of an air conditioning device. In the heater core 6, heat exchange between cooling water and air conditioning air flowing through the duct is performed.

The EGR cooler 7 is provided at the EGR flow path 15. In the EGR cooler 7, heat exchange between cooling water flowing through the EGR flow path 15 and an EGR gas is performed.

In the cooling system 1 as described above, cooling water passing through the engine 2 in the main flow path 10 is selectively distributed to the various flow paths 11 to 15 by an operation of the control valve 8 after flowing into the control valve 8. As a result, an increase in temperature at an early stage, high-water temperature (optimum temperature) control, or the like can be realized and an improvement in vehicle fuel efficiency can be achieved.

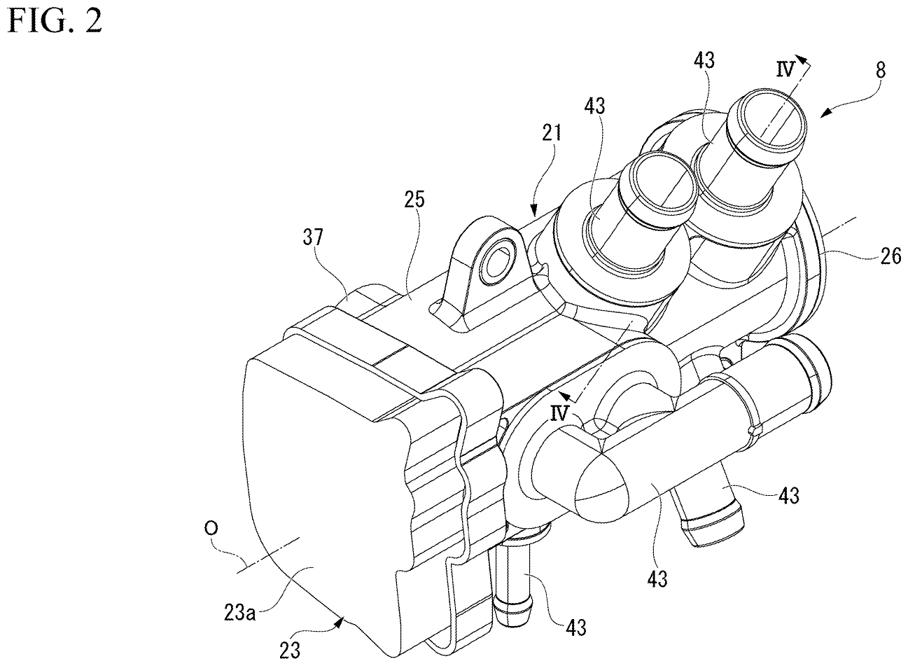

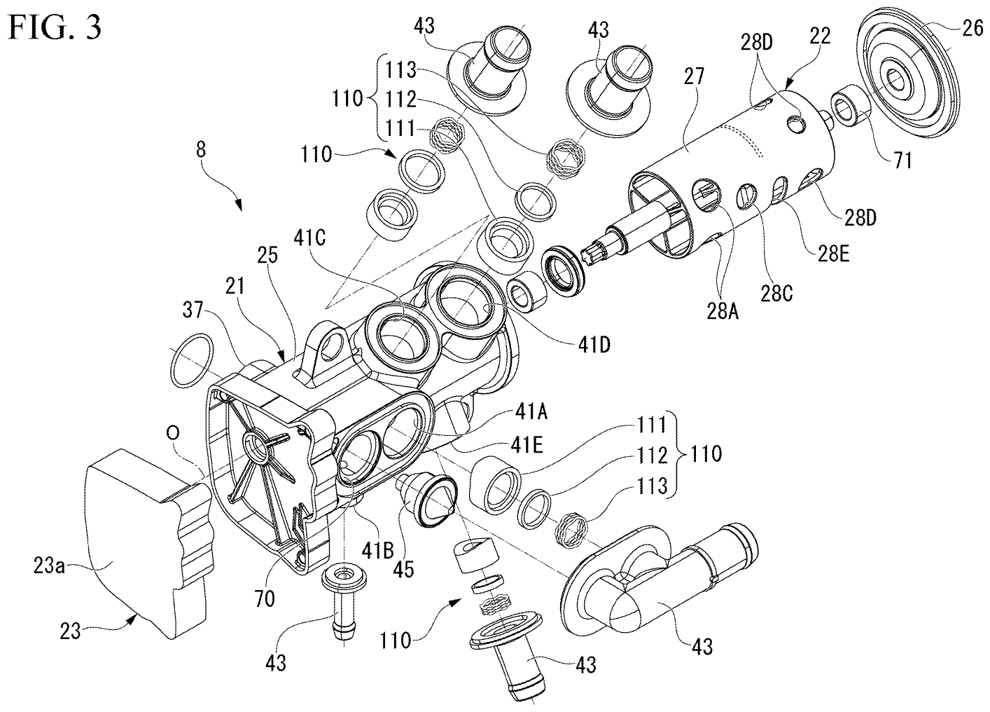

FIG. 2 is a perspective view of the control valve 8 according to the embodiment. FIG. 3 is an exploded perspective view of the control valve 8.

As shown in FIGS. 2 and 3, the control valve 8 is provided with a valve housing 21, a valve body 22 that is rotatably disposed in the valve housing 21, and a drive unit 23 that rotates and drives the valve body 22.

The valve housing 21 is provided with a housing main body 25 having a bottomed tubular shape and a lid 26 that closes an opening portion of the housing main body 25. Note that, in the following description, a direction parallel to an axis O of the valve housing 21 will be simply referred to as an axial direction. The valve housing 21 is formed in a tubular shape long in the axial direction. A peripheral wall of the housing main body 25 is provided with an inflow port 37 and a plurality of discharge ports 41A, 41B, 41C, 41D, and 41E. Cooling water (liquid) flows into the inflow port 37 from the outside (engine 2). The discharge port 41A is connected to, for example, the radiator flow path 11. The discharge port 41B is connected to, for example, the EGR flow path 15. The discharge port 41C is connected to, for example, the bypass flow path 12. The discharge port 41D is connected to, for example, the warming flow path 13. The discharge port 41E is connected to, for example, the air conditioning flow path 14. Through the discharge ports 41A, 41B, 41C, 41D, and 41E, cooling water (liquid) flowing into the valve housing 21 is discharged to each flow path.

The inflow port 37 is provided in an outer circumference of the housing main body 25 while being close to a first side in the axial direction. The discharge ports 41A, 41B, 41C, 41D, and 41E are provided at appropriate positions in the outer circumference of the housing main body 25 while being separated from each other in the axial direction and a circumferential direction.

As shown in FIG. 3, the discharge ports 41A, 41B, 41C, 41D, and 41E are formed in an outer circumferential wall of the housing main body 25. A joint member 43 is bonded to a circumferential edge of each of the discharge ports 41A, 41B, 41C, 41D, and 41E. The joint members 43 are for connecting discharge pipes to the discharge ports 41A, 41B, 41C, 41D, and 41E.

In each of the discharge ports 41A, 41C, 41D, and 41E other than the discharge port 41B connected to the EGR flow path 15, a seal mechanism 110 is provided. Each seal mechanism 110 includes a sealing tubular member 111, a seal ring 112, and an urging spring 113 which will be described later.

Note that, a fail opening 70 is formed in an inner portion of the valve housing 21 that faces the inflow port 37. The fail opening 70 is configured to be opened and closed by a thermostat 45. The discharge port 41B connected to the EGR flow path 15 is open in a direction orthogonal to a direction in which the fail opening 70 is open. According to this configuration, cooling water flowing into the valve housing 21 through the inflow port 37 flows into the EGR flow path 15 through the discharge port 41B after coming into contact with the thermostat 45. Therefore, in the control valve 8, a stream toward the discharge port 41B can be formed near the thermostat 45 in the valve housing 21. In this manner, a stagnation point formed near the thermostat 45 is suppressed.

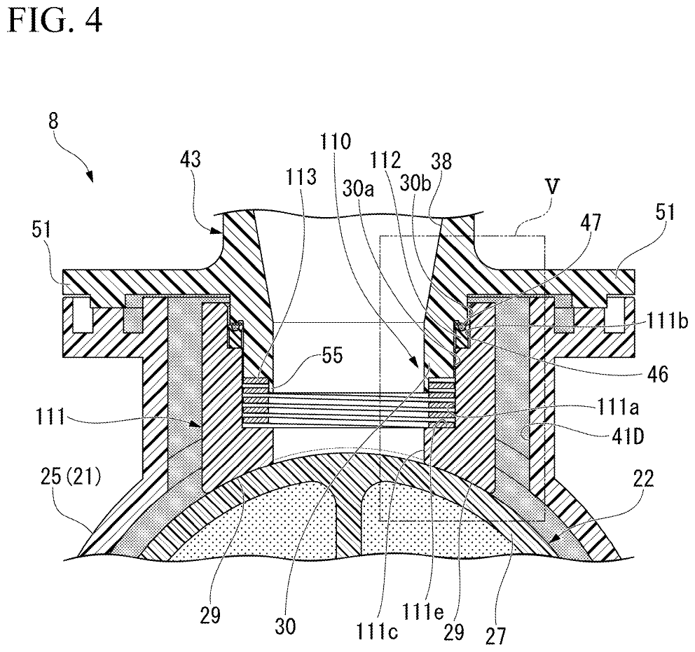

The discharge ports 41A, 41C, 41D, and 41E basically have the same structure as each other even though the sizes and the shapes thereof are slightly different from each other and the seal mechanisms 110 provided in the discharge ports 41A, 41C, 41D, and 41E basically have the same structure as each other even though the sizes and the shapes thereof are slightly different from each other. Therefore, hereinafter, the discharge port 41D connected to the warming flow path 13 and the seal mechanism 110 provided in the discharge port 41D will be used as representative examples and the discharge port 41D, the seal mechanism 110, and the valve body 22 will be described with reference to FIGS. 3 and 4.

FIG. 4 is a sectional view of the control valve 8 taken along line IV-IV in FIG. 2.

As shown in FIG. 3, the valve body 22 is rotatably accommodated in the valve housing 21. The valve body 22 is provided with a cylindrical wall (hollow rotary body) 27 that is disposed to be coaxial with the axis O of the valve housing 21. A plurality of valve holes 28A, 28C, 28D, and 28E through which the inside and the outside of the cylindrical wall 27 communicate with each other are formed in appropriate positions in the cylindrical wall 27. The valve holes 28A, 28C, 28D, and 28E are provided corresponding to the discharge ports 41A, 41C, 41D, and 41E. The valve holes 28A, 28C, 28D, and 28E are provided to be separated from each other in the axial direction of the cylindrical wall 27. The discharge port 41A is formed at a position at which at least a portion of the discharge port 41A overlaps a rotation route of each valve hole 28A of the cylindrical wall 27. The discharge port 41C is formed at a position at which at least a portion of the discharge port 41C overlaps a rotation route of each valve hole 28C of the cylindrical wall 27. The discharge port 41D is formed at a position at which at least a portion of the discharge port 41D overlaps a rotation route of each valve hole 28D of the cylindrical wall 27. The discharge port 41E is formed at a position at which at least a portion of the discharge port 41E overlaps a rotation route of each valve hole 28E of the cylindrical wall 27.

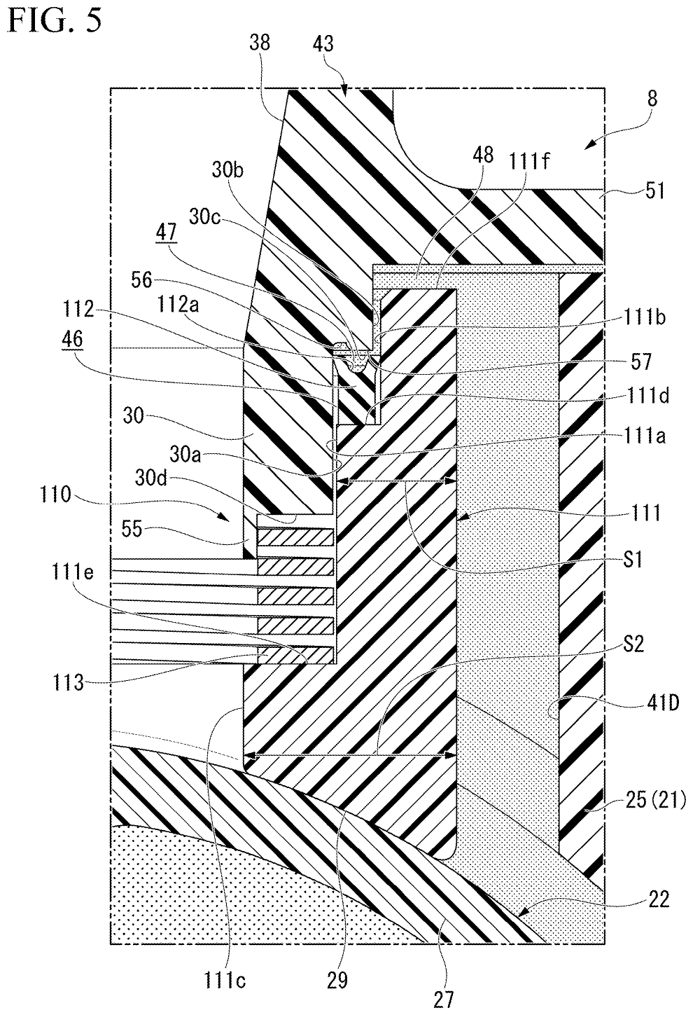

FIG. 5 is an enlarged view of part V in FIG. 4.

As shown in FIGS. 4 and 5, the sealing tubular member 111 of the seal mechanism 110 is formed in an approximately cylindrical shape as a whole. An outer circumferential surface of the sealing tubular member 111 is slidably held at the joint member 43 of the corresponding discharge port 41D. The sealing tubular member 111 communicates with a path hole 38 of the joint member 43. An end surface of the sealing tubular member 111 that faces the valve body 22 is provided with an arc-shaped valve slide contact surface 29 that slidably abuts an outer surface of the cylindrical wall 27 at a position at which at least a portion of the valve slide contact surface 29 overlaps a rotation route of the corresponding valve holes 28D of the valve body 22. Note that, all of the sealing tubular member 111 and the cylindrical wall 27 of the valve body 22 are formed of resin material.

When the valve body 22 is at a rotation position at which the valve holes 28D and the sealing tubular member 111 corresponding to the valve holes 28D communicate with each other, the valve body 22 allows cooling water to flow out to the discharge port 41D from a region inside the cylindrical wall 27 via the sealing tubular member 111. When the valve body 22 is at a rotation position at which the valve holes 28D and the sealing tubular member 111 corresponding to the valve holes 28D do not communicate with each other, the valve body 22 blocks cooling water flowing out to the discharge port 41D from the region inside the cylindrical wall 27 via the sealing tubular member 111.

The rotation position of the valve body 22 is appropriately adjusted by the drive unit 23 (refer to FIGS. 2 and 3) provided in a bottom wall portion of the housing main body 25. The drive unit 23 is configured such that a motor, a deceleration mechanism, a control board, or the like (not shown) are accommodated in a casing 23a.

As shown in FIGS. 4 and 5, the joint member 43 is provided with a cylindrical tubular portion 30 that protrudes in a direction toward the valve body 22 from an inner end portion (near discharge port 41D) of the path hole 38. The tubular portion 30 is provided with a small-diameter outer circumferential surface 30a and a large-diameter outer circumferential surface 30b. The small-diameter outer circumferential surface 30a slidably holds the sealing tubular member 111. The large-diameter outer circumferential surface 30b is formed to be increased in diameter in a stepped shape from an end portion of the small-diameter outer circumferential surface 30a that is separate from the valve body 22. The small-diameter outer circumferential surface 30a and the large-diameter outer circumferential surface 30b are connected to each other by an annular level difference surface 30c. A cylindrical restriction tube (restriction portion) 55 that extends in a direction toward the valve body 22 is provided to extend from a radially inner region of an end surface 30d of the tubular portion 30 that is close to the valve body 22.

The joint member 43 is provided with a bonded flange 51 that extends radially outward from a root portion of the tubular portion 30. The bonded flange 51 is bonded to an outer circumferential edge portion of the discharge port 41D of the valve housing 21 through vibration welding or the like.

The sealing tubular member 111 is provided with a medium-diameter inner circumferential surface 111a, a large-diameter inner circumferential surface 111b, and a small-diameter inner circumferential surface 111c. The medium-diameter inner circumferential surface 111a is slidably fitted onto the small-diameter outer circumferential surface 30a of the joint member 43. The large-diameter inner circumferential surface 111b is formed to be increased in diameter in a stepped shape from an end portion of the medium-diameter inner circumferential surface 111a that is separated from the valve body 22. The small-diameter inner circumferential surface 111c is formed to be decreased in diameter in a stepped shape from an end portion of the medium-diameter inner circumferential surface 111a that is close to the valve body 22. The medium-diameter inner circumferential surface 111a and the large-diameter inner circumferential surface 111b are connected to each other by a first connection surface 111d. The medium-diameter inner circumferential surface 111a and the small-diameter inner circumferential surface 111c are connected to each other by a second connection surface 111e. Both of the first connection surface 111d and the second connection surface 111e are configured as annular flat surfaces.

An annular seal accommodation space 46 surrounded by the large-diameter inner circumferential surface 111b and the small-diameter outer circumferential surface 30a is provided between the level difference surface 30c of the joint member 43 and the first connection surface 111d of the sealing tubular member 111. The seal ring 112 is accommodated in the seal accommodation space 46.

The seal ring 112 is an annular elastic member having a Y-shaped section. The seal ring 112 is accommodated in the seal accommodation space 46 with an opening side of the Y-shape facing the level difference surface 30c. Side end portions of a forked portion of the Y-shape of the seal ring 112 are in close contact with the large-diameter inner circumferential surface 111b and the small-diameter outer circumferential surface 30a. A space between the seal ring 112 and the level difference surface 30c of the tubular portion 30 is a liquid pressure chamber 47 into which the pressure of cooling water in the valve housing 21 is introduced. A continuous introduction path 48 is provided between the large-diameter outer circumferential surface 30b of the tubular portion 30 and the large-diameter inner circumferential surface 111b of the sealing tubular member 111 and between a rear surface of a root portion of the bonded flange 51 of the joint member 43 and an end surface 111f of the sealing tubular member 111 that is separate from the valve body 22. Through the introduction path 48, the pressure of cooling water in the valve housing 21 is introduced into the liquid pressure chamber 47. The rear surface of the root portion of the bonded flange 51 of the joint member 43 and the end surface 111f of the sealing tubular member 111 that is separate from the valve body 22 constitute first facing portions in the present embodiment.

In the control valve 8 according to the present embodiment, a surface 112a of the seal ring 112 that faces the liquid pressure chamber 47 and the end surface 111f of the sealing tubular member 111 that is adjacent to the liquid pressure chamber 47 constitute a pressure receiving urging surface. The pressure receiving urging surface receives the pressure of cooling water in the valve housing 21 and generates a pressing force in a direction toward the valve body 22 with respect to the sealing tubular member 111.

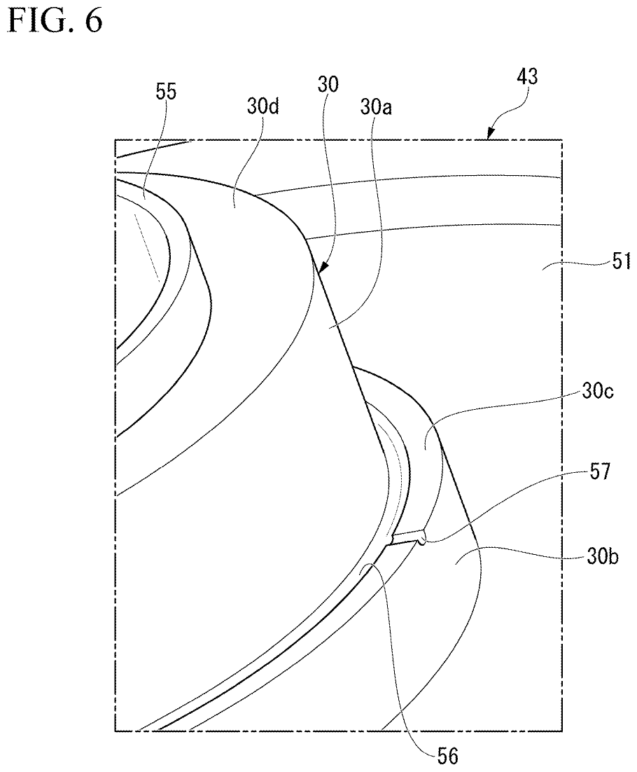

FIG. 6 is a perspective view of the joint member 43 as seen from a side at which the tubular portion 30 protrudes.

As shown in FIGS. 5 and 6, an annular groove 56 is formed in a radially inner region of the level difference surface 30c of the tubular portion 30. A closeness prevention groove 57 is formed in an outer region that is higher than the annular groove 56. Through the closeness prevention groove 57, an inner portion (liquid pressure chamber 47) of the annular groove 56 and a region (introduction path 48) outside the tubular portion 30 communicate with each other. As shown in FIG. 5, the seal ring 112 can abut onto an outer region of the level difference surface 30c of the tubular portion 30. Therefore, in a case where there is no closeness prevention groove 57, the inside of the liquid pressure chamber 47 may come into close contact such that no pressing force is generated when the seal ring 112 is strongly pressed against the outer region of the level difference surface 30c. However, in the present embodiment, the closeness prevention groove 57 is provided and thus it is possible to prevent the inside of the liquid pressure chamber 47 from being tightly closed in advance.

The urging spring 113 is interposed between the second connection surface 111e of the sealing tubular member 111 and the end surface 30d of the tubular portion 30 (joint member 43). The urging spring 113 has a coil-like shape and urges the sealing tubular member 111 in a direction toward the valve body 22. The urging spring 113 is preliminarily installed inward of the medium-diameter inner circumferential surface 111a of the sealing tubular member 111 with a first side end portion thereof placed on the second connection surface 111e and is installed onto the joint member 43 along with the sealing tubular member 111 in the above-described state. At this time, the 30 of the joint member 43 is fitted into the sealing tubular member 111. The urging spring 113 abuts the second connection surface 111e of the sealing tubular member 111 and the end surface 30d of the tubular portion 30. An inner circumferential edge portion of the urging spring 113 that is on the tubular portion 30 side is disposed outward of the restriction tube 55 that protrudes from the tubular portion 30. Accordingly, the urging spring 113 is restricted from positionally deviating relative to the tubular portion 30 in a radial direction of the tubular portion 30. The second connection surface 111e of the sealing tubular member 111 and the end surface 30d of the tubular portion 30 (joint member 43) constitute second facing portions in the present embodiment.

In the control valve 8 according to the present embodiment, an end portion of the medium-diameter inner circumferential surface 111a of the sealing tubular member 111 that is on the valve body 22 side is provided with the small-diameter inner circumferential surface 111c and the second connection surface 111e such that the small-diameter inner circumferential surface 111c and the second connection surface 111e project radially inward. Therefore, it is possible to support the first side end portion of the urging spring 113 with a radially inner portion of the sealing tubular member 111 and to increase the slide contact area of the valve slide contact surface 29 of the sealing tubular member 111 radially inward.

The entire area of the valve slide contact surface 29 of the sealing tubular member 111 over an area from a radially outer end of the sealing tubular member 111 to a radially inner end of the sealing tubular member 111 is formed to have the same radius of curvature as a region of the outer surface of the cylindrical wall 27 of the valve body 22 that abuts the sealing tubular member 111. Therefore, the valve slide contact surface 29 basically abuts the outer surface of the cylindrical wall 27 throughout the area from the radially outer end of the sealing tubular member 111 to the radially inner end of the sealing tubular member 111. However, a gap between a radially outer region of the valve slide contact surface 29 and the cylindrical wall 27 may be slightly increased due to manufacturing errors and installing errors of the sealing tubular member 111.

Here, an area S1 of the pressure receiving urging surface (surface 112a of seal ring 112 that faces liquid pressure chamber 47 and end surface 111f of sealing tubular member 111) of the sealing tubular member 111 and an area S2 of the valve slide contact surface 29 are set to satisfy Equations (1) and (2) as follows.

S1<S2≤S1/k (1)

α≤k<1 (2)

k: The pressure reduction constant of liquid flowing through a slight gap between the valve slide contact surface 29 and the valve body 22.

α: The lower limit value of the pressure reduction constant determined by the physical properties of the liquid.

The area S1 of the pressure receiving urging surface and the area S2 of the valve slide contact surface 29 mean areas at a time of being projected onto a plane orthogonal to the axial direction of the sealing tubular member 111.

α in Equation (2) is a standard value of the pressure reduction constant determined by the kind of liquid or a usage environment (for example, temperature) and α=1/2 under a usual usage environment in the case of water. In a case where there is a change in physical properties of liquid to be used, α is changed to α=1/3 or the like.

The pressure reduction constant k in Equation (2) becomes α (for example, 1/2), which is the standard value of the pressure reduction constant, when the valve slide contact surface 29 uniformly abuts the cylindrical wall 27 over an area from a radially outer end to a radially inner end thereof.

There is a case where a facing gap between the valve slide contact surface 29 and the cylindrical wall 27 becomes not uniform over an area from the radially outer end to the radially inner end of the valve slide contact surface 29 and a facing gap between outer ends becomes large due to manufacturing errors and installing errors of the sealing tubular member 111, foreign substances, and the like. In this case, the pressure reduction constant k in Equation (2) becomes gradually close to k=1.

In the control valve 8 according to the present embodiment, a relationship between the area S1 (area S1 of pressure receiving urging surface), which is the sum of the area of the surface 112a of the seal ring 112 that faces the liquid pressure chamber 47 and the area of the end surface 111f of the sealing tubular member 111, and the area S2 of the valve slide contact surface 29 is determined by Equations (1) and (2) on the assumption that a slight gap is provided between the valve slide contact surface 29 of the sealing tubular member 111 and the cylindrical wall 27 (valve body 22) to allow the valve slide contact surface 29 and the cylindrical wall 27 to slide against each other.

The pressure of cooling water in the valve housing 21 acts on the pressure receiving urging surface of the sealing tubular member 111 as it is. The pressure of cooling water in the valve housing 21 does not act on the valve slide contact surface 29 as it is. That is, the pressure of cooling water acting on the valve slide contact surface 29 is accompanied by pressure reduction when the cooling water flows through the slight gap between the valve slide contact surface 29 and the cylindrical wall 27 in a direction from the radially outer end to the radially inner end. At this time, the pressure of cooling water in the valve housing 21 flowing through the slight gap gradually decreases toward the inside of the discharge port 41D in which the pressure is low and the sealing tubular member 111 is pressed in a direction away from the valve body 22.

A force which is obtained by multiplying the area S1 of the pressure receiving urging surface by the pressure P in the valve housing 21 acts on the pressure receiving urging surface of the sealing tubular member 111 as it is. A force which is obtained by the area S2 of the valve slide contact surface 29 by the pressure P in the valve housing 21 and the pressure reduction constant k acts on the valve slide contact surface 29 of the sealing tubular member 111.

In the control valve 8 according to the present embodiment, the areas S1 and S2 are set to satisfy a relationship of k×S2≤S1 which is obvious from Equation (1). Therefore, a relationship of P×k×S2≤P×S1 is also satisfied.

Therefore, a force F1 (F1=P×S1) in a pressing direction that acts on the pressure receiving urging surface of the sealing tubular member 111 is equal to or greater than a force F2 (F2=P×k×S2) in a floating direction that acts on the valve slide contact surface 29 of the sealing tubular member 111. Therefore, in the control valve 8 according to the present embodiment, it is possible to close the end portion of the sealing tubular member 111 by means of the cylindrical wall 27 of the valve body 22 with only the relationship between the pressures of cooling water in the valve housing 21. Actually, an urging force in a direction toward the valve body 22 which is generated by the urging spring 113 is further applied to the sealing tubular member 111.

Meanwhile, in the control valve 8 according to the present embodiment, the area S1 of the pressure receiving urging surface is smaller than the area S2 of the valve slide contact surface 29 as shown in Equation (1). Therefore, in the control valve 8, even in a case where the pressure of cooling water in the valve housing 21 is large, pressing of the valve slide contact surface 29 of the sealing tubular member 111 with an excessive force against the cylindrical wall 27 of the valve body 22 can be limited. Accordingly, in a case where the control valve 8 is adopted, it is possible to avoid an increase in size and output of the drive unit 23 that rotates and drives the valve body 22 and it is possible to limit early-stage wear of the sealing tubular member 111 or a bearing portion 71 (refer to FIG. 3) of the valve body 22.

Accordingly, in a case where the control valve 8 according to the present embodiment is adopted, it is possible to appropriately open and close the end portion of the sealing tubular member 111 by means of the cylindrical wall 27 of the valve body 22 while limiting the pressing of the sealing tubular member 111 against the cylindrical wall 27 of the valve body 22 with an excessive force.

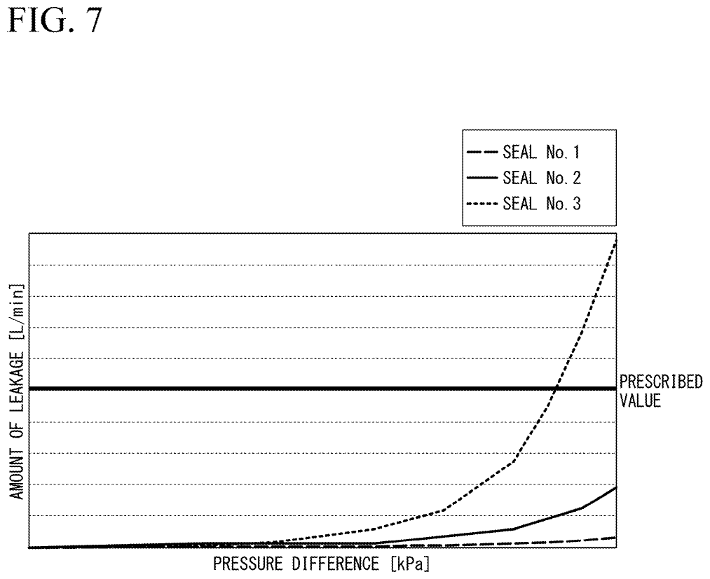

Here, by using cooling water (k in Equation (2) is k=0.5), a liquid coolant leakage test and a wear test of the valve slide contact surface 29 were performed with respect to the control valve 8 according to the present embodiment in which the area S1 of the pressure receiving urging surface and the area S2 of the valve slide contact surface 29 satisfy Equation (1) and control valves according to two comparative examples in which the areas S1 and S2 do not satisfy Equation (1). The result of the wear test was as shown in following Table 1 and a graph in FIG. 7.

In Table 1 and FIG. 7, “No2” corresponds to the control valve 8 according to the embodiment in which Equation (1) is satisfied. “No. 1” corresponds to a control valve in a comparative example in which the areas S1 and S2 satisfy S1>S2 and S2<S1/k. “No. 3” corresponds to a control valve in a comparative example in which the areas S1 and S2 satisfy S1<S2 and S2>S1/k.

TABLE 1

| | S1 | S2 | | Sealing | |
|---|---|---|---|---|---|
| No. | [mm²] | [mm²] | Region of S2 | Properties | Wear of Seal |
| 1 | 207.3 | 165.9 | Out of Range | Favorable | Significant |
| | | | Indicated by | | |
| | | | Equation and | | |
| | | | Smaller than S1 | | |
| 2 | 207.3 | 311.0 | Falls in Range | Favorable | Insignificant |
| | | | Indicated by | | |
| | | | Equation | | |
| 3 | 207.3 | 472.7 | Out of Range | Not | Insignificant |
| | | | Indicated by | Favorable | |
| | | | Equation and | | |
| | | | Greater than S1/k | | |

*Test was Performed by Using Water. Pressure Reduction Constant k Was 0.5.

In the liquid coolant leakage test, the valve body 22 of the control valve 8 was at a rotation position at which the valve hole 28D of the valve body 22 and the sealing tubular member 111 corresponding to the valve hole 28D did not communicate with each other. In this state, the amount of liquid coolant leaking from the discharge port was measured with the pressure in the inflow port gradually increased. In addition, in the wear test of the valve slide contact surface 29, the state of wear of the valve slide contact surface 29 was determined with the cylindrical wall 27 of the valve body 22 rotated for a predetermined time while keeping the pressure in the inflow port constant.

As obvious from Table 1 and FIG. 6, in the comparative example of No. 1 in which the area S2 of the valve slide contact surface 29 was smaller than the area S1 of a joint side end surface (pressure receiving urging surface) 66 (S1>S2), the amount of cooling water leakage was small. However, in the comparative example of No. 1, wear of the valve slide contact surface 29 was more significant in comparison with the control valves in No. 1 and No. 3. In addition, in the comparative example of No. 3 in which the area S2 of the valve slide contact surface 29 was greater than S1/k, wear of the valve slide contact surface 29 was insignificant. However, in the comparative example of No. 3, the amount of cooling water leakage was increased to be greater than a prescribed value.

On the other hand, in the case of the control valve 8 according to the embodiment of No. 2 in which the areas S1 and S2 satisfy Equation (1), wear of the valve slide contact surface 29 was insignificant and cooling water leakage was below the prescribed value.

As described above, in the control valve 8 according to the present embodiment, a space between the small-diameter outer circumferential surface 30a of the joint member 43 and the large-diameter inner circumferential surface 111b of the sealing tubular member 111 is tightly closed by the seal ring 112 and the surface of the seal ring 112 that faces the liquid pressure chamber 47 and the end surface 111f of the sealing tubular member 111 constitute the pressure receiving urging surface which is opposite to the valve slide contact surface 29. A portion of the sealing tubular member 111 that is positioned radially inward of a seal ring installment portion is provided with the second connection surface 111e that receives a pressing load from the urging spring 113.

Therefore, in the control valve 8 according to the present embodiment, at all times, the valve slide contact surface 29 of the sealing tubular member 111 receives the pressing load in a direction to the cylindrical wall 27 of the valve body 22 from the urging spring 113 at a position close to the radially inner side of the sealing tubular member 111. Accordingly, even in a case where wear of the valve slide contact surface 29 progresses from the radially outer side with the valve slide contact surface 29 used for a period of time, the radially inner region of the valve slide contact surface 29 can be reliably brought into press contact with the outer surface of the cylindrical wall 27 by means of the pressing load from the urging spring 113. Therefore, in a case where the control valve 8 according to the present embodiment is adopted, it is possible to maintain a high sealing performance of the valve slide contact surface 29 of the sealing tubular member 111 for a long period of time.

In the control valve 8 according to the present embodiment, the area S1 of the pressure receiving urging surface of the sealing tubular member 111 and the area S2 of the valve slide contact surface 29 are set to satisfy (1) and (2) as described above. Therefore, it is possible maintain the sealing performance of the sealing tubular member 111 obtained by a liquid pressure at all times and to suppress the valve slide contact surface 29 being pressed against the outer surface of the cylindrical wall 27 of the valve body 22 with an excessive force even in a case where the pressure of liquid in the valve housing 21 is increased. Therefore, in a case where the control valve 8 according to the present embodiment is adopted, it is possible to avoid an increase in size and output of the drive unit 23 that rotates and drives the valve body 22 and it is possible to suppress an increase in wear of the sealing tubular member 111 or the bearing portion 71 of the valve body 22.

In the present embodiment, the liquid pressure acts on the seal ring 112 through a gap between the small-diameter outer circumferential surface 30a and the large-diameter inner circumferential surface 111b. Accordingly, the seal ring 112 presses the sealing tubular member 111 toward the valve body 22 via the first connection surface 111d. That is, surfaces of the seal ring 112 and the sealing tubular member 111 that face a side opposite to the valve body 22 side in the axial direction of the sealing tubular member 111 constitute the pressure receiving urging surface. Accordingly, it is easy to secure the area of the pressure receiving urging surface while securing the sealing properties between the tubular portion 30 and the sealing tubular member 111.

In the control valve 8 according to the present embodiment, the closeness prevention groove 57 through which the liquid pressure chamber 47 and the outside thereof communicate with each other is formed in the level difference surface 30c formed on the tubular portion 30 of the joint member 43. Therefore, even in a case where the seal ring 112 is pressed against the level difference surface 30c with a large force, cooling water in the valve housing 21 can be prevented from becoming not able to be introduced into the liquid pressure chamber 47 with the liquid pressure chamber 47 tightly closed. Accordingly, it is possible to prevent a pressure receiving area in a valve body pressing direction on the sealing tubular member 111 side from being substantially decreased with the seal ring 112 fixed onto the level difference surface 30c on the joint member 43 side. As a result, it is possible to maintain the sealing performance of the sealing tubular member 111.

In the control valve 8 according to the present embodiment, the restriction tube 55 that extends in a direction toward the valve body and restricts the urging spring 113 from being displaced radially inward is provided to extend from the radially inner region of the end surface of the tubular portion 30 of the joint member 43. Therefore, it is possible to restrict the urging spring 113 from positionally deviating relative to the joint member 43 in the radial direction by means of the restriction tube 55 and to limit turbulence which is generated when cooling water flowing inside the sealing tubular member 111 flows in a direction toward the medium-diameter inner circumferential surface 111a of the sealing tubular member 111.

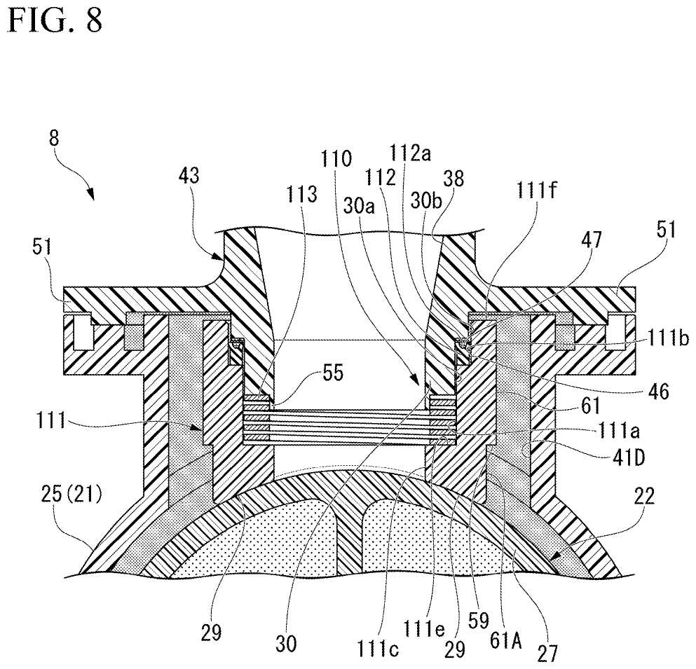

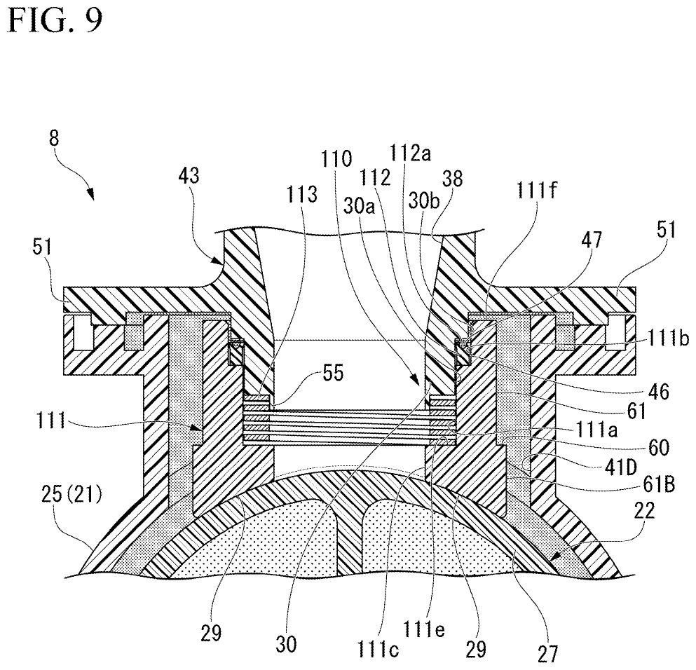

FIGS. 8 and 9 are sectional views similar to FIG. 4 and show modification examples of the above-described embodiment. Note that, hereinafter, the same parts as those in the above-described basic embodiment will be given the same reference numerals and repetitive descriptions thereof will be omitted.

In a modification example shown in FIG. 8, an edge of an outer circumferential surface 61 of the sealing tubular member 111 that is close to the valve body 22 is provided with a size reduction outer circumferential surface 61A that is decreased in diameter in a stepped shape. An end portion of the size reduction outer circumferential surface 61A that is on the valve body 22 side is aligned with the valve slide contact surface 29. A level difference surface connecting the outer circumferential surface 61 and the size reduction outer circumferential surface 61A to each other is an auxiliary pressure receiving surface 59 that faces the same direction as the valve slide contact surface 29. In the case of this modification example, the pressure of cooling water in the valve housing 21 acts on the auxiliary pressure receiving surface 59 and thus it is possible to limit the pressing force of the sealing tubular member 111 with respect to the valve body 22.

In the present modification example, a portion, which is obtained by subtracting a portion corresponding to the area of the auxiliary pressure receiving surface 59 from a portion obtained by adding up the areas of the surface 112a of the seal ring 112 that faces the liquid pressure chamber 47 and the end surface 111f of the sealing tubular member 111, is the pressure receiving urging surface.

In a modification example shown in FIG. 9, the outer circumferential surface 61 of the sealing tubular member 111 is provided with a size increase outer circumferential surface 61B that is increased in diameter in a stepped shape from an end portion close to the valve body 22. An end portion of the size increase outer circumferential surface 61B that is on the valve body 22 side is aligned with the valve slide contact surface 29. A level difference surface connecting the outer circumferential surface 61 and the size increase outer circumferential surface 61B to each other is an auxiliary pressure receiving surface 60 that is opposite to the valve slide contact surface 29. In the case of this modification example, the pressure of cooling water in the valve housing 21 acts on the auxiliary pressure receiving surface 60 and thus the sealing properties of the sealing tubular member 111 with respect to the valve body 22 are further improved.

In the present modification example, the surface 112a of the seal ring 112 that faces the liquid pressure chamber 47, the end surface 111f of the sealing tubular member 111, and the auxiliary pressure receiving surface 60 constitute the pressure receiving urging surface.

### Second Embodiment

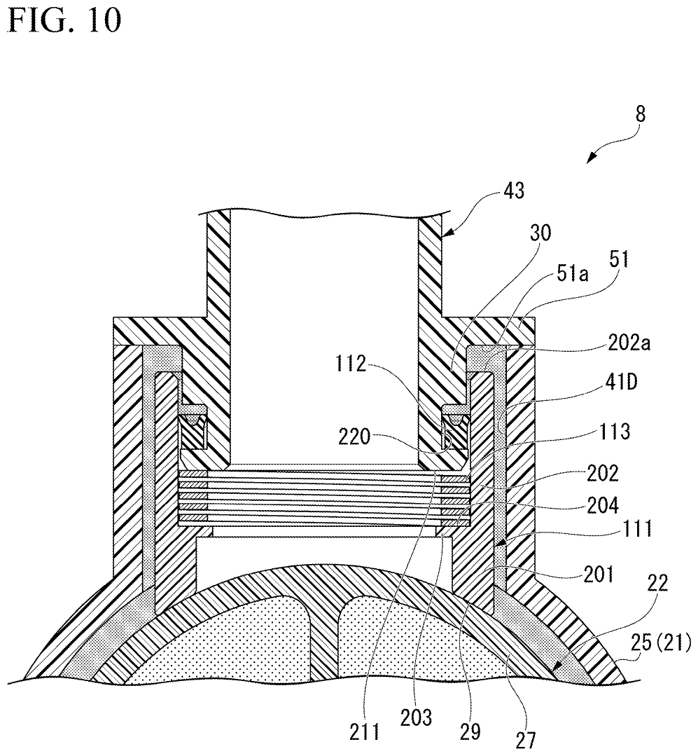

FIG. 10 is a sectional view corresponding to FIG. 4 and shows the control valve 8 according to a second embodiment.

As shown in FIG. 10, the inner diameter of the sealing tubular member 111 increases in a stepwise manner away from the valve body 22 in the axial direction of the sealing tubular member 111. Specifically, the sealing tubular member 111 is provided with a small-diameter portion 201 and a large-diameter portion 202. In the following description, the axial direction of the sealing tubular member 111 may be simply referred to as a seal axial direction and the radial direction of the sealing tubular member 111 may be referred to as a seal radial direction.

A surface of the small-diameter portion 201 that faces the valve body 22 in the seal axial direction constitutes the valve slide contact surface 29. An inner flange portion 203 that protrudes inward in the seal radial direction is formed on an end portion of the small-diameter portion 201 that is positioned on a side opposite to the valve body 22 side in the seal axial direction. A surface of the small-diameter portion 201 and the inner flange portion 203 that faces a side opposite to the valve body 22 side in the seal axial direction constitutes a level difference surface 204 aligned with an inner circumferential surface of the large-diameter portion 202.

A surface of the large-diameter portion 202 that faces the side opposite to the valve body 22 side in the seal axial direction constitutes a pressure receiving urging surface 202a that faces a bonded flange portion 51 in the seal axial direction. The pressure receiving urging surface 202a of the large-diameter portion 202 and a facing surface 51a of the bonded flange portion 51 that faces the pressure receiving urging surface 202a constitute first facing portions in the present embodiment. In an example shown in FIG. 10, the outer diameter of the sealing tubular member 111 is uniform over the entire area thereof in the seal axial direction.

The tubular portion 30 of the joint member 43 is disposed inward of the large-diameter portion 202. The outer circumferential surface of the tubular portion 30 is close to or abuts the inner circumferential surface of the large-diameter portion 202 in the seal radial direction. An end surface 211 of the tubular portion 30, which faces the valve body 22 in the seal axial direction, faces the level difference surface 204 in the seal axial direction. The end surface 211 and the level difference surface 204 constitute second facing portions that are positioned inward of the first facing portions in the seal radial direction. The urging spring 113 is interposed between the end surface 211 and the level difference surface 204. The urging spring 113 urges the sealing tubular member 111 toward the valve body 22 via the level difference surface 204.

An accommodation groove 220 is formed in the outer circumferential surface of the tubular portion 30. The accommodation groove 220 is formed in an annular shape extending over the entire circumference of the tubular portion 30. In the accommodation groove 220, the seal ring 112 is accommodated. The forked portion of the seal ring 112 is in close contact with the inner circumferential surface of the large-diameter portion 202 and an inner surface of the accommodation groove 220 in the seal radial direction. Accordingly, a space between the tubular portion 30 and the large-diameter portion 202 is sealed.

According to the present embodiment, the following effect can be achieved in addition to the same effect as in the first embodiment, for example.

Since one component of the sealing tubular member 111 constitutes the pressure receiving urging surface 202a, it is easy to manage the dimensions of the pressure receiving urging surface in comparison with a case where a plurality of components constitute the pressure receiving urging surface.

In the present embodiment, the seal ring 112 is accommodated in the accommodation groove 220 of the tubular portion 30.

According to this configuration, it is possible to install the joint member 43 in the discharge port 41D in a state where the seal ring 112 is held in the accommodation groove 220. Accordingly, it is possible to achieve simplification of the configuration and an improvement in installing properties.

In the present embodiment, the seal ring 112 is in contact with the sealing tubular member 111 only in the seal radial direction (is not in contact with sealing tubular member 111 in seal axial direction). Therefore, although the seal ring 112 does not function as the pressure receiving urging surface, the liquid pressure acts thereon through a gap between the tubular portion 30 and the large-diameter portion 202. In this case, the frictional resistance between the large-diameter portion 202 and the seal ring 112 can be increased with the seal ring 112 crushed in the seal axial direction. Accordingly, it is possible to suppress wobbling or the like of the sealing tubular member 111 and to improve the sealing properties between the sealing tubular member 111 and the cylindrical wall 27.

### Third Embodiment

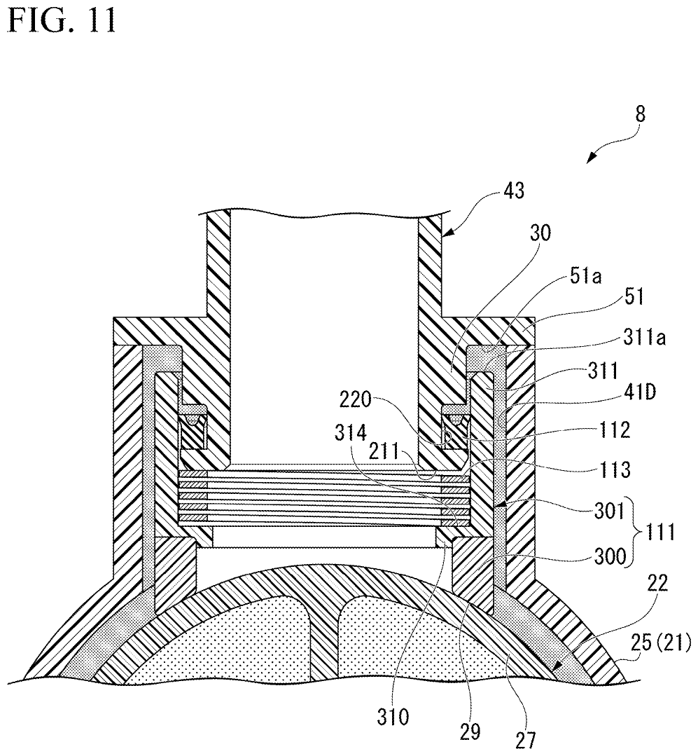

FIG. 11 is a sectional view corresponding to FIG. 4 and shows the control valve 8 according to the third embodiment.

As shown in FIG. 11, the sealing tubular member 111 is provided with a seal portion 300 and a holder portion 301. The seal portion 300 and the holder portion 301 are formed in tubular shapes coaxially arranged in the seal axial direction.

The seal portion 300 is disposed closer to the valve body 22 than the holder portion 301 in the seal axial direction. A surface of the seal portion 300 that faces the valve body 22 in the seal axial direction constitutes the valve slide contact surface 29.

The inner diameter of the holder portion 301 increases in a stepwise manner away from the valve body 22. Specifically, the holder portion 301 is provided with a small-diameter portion 310 and a large-diameter portion 311.

The small-diameter portion 310 is disposed in the seal portion 300. The small-diameter portion 310 may be inserted into the seal portion 300 and may be fitted (press-fitted) into the seal portion 300. A surface of the small-diameter portion 310 that faces a side opposite to the valve body 22 side constitutes a level difference surface 314 aligned with an inner circumferential surface of the large-diameter portion 311. The level difference surface 314 and the end surface 211 of the tubular portion 30 constitute second facing portions facing in the seal axial direction. The urging spring 113 is interposed between the end surface 211 and the level difference surface 314.

A surface of the large-diameter portion 311 that faces the side opposite to the valve body 22 side in the seal axial direction constitutes a pressure receiving urging surface 311a that faces the bonded flange portion 51 in the seal axial direction. The pressure receiving urging surface 311a of the large-diameter portion 311 and the facing surface 51a of the bonded flange portion 51 that faces the pressure receiving urging surface 311a constitute first facing portions in the present embodiment.

According to the present embodiment, the following effect can be achieved in addition to the same effect as in the second embodiment, for example.

In the present embodiment, the sealing tubular member 111 divides into the seal portion 300 and the holder portion 301. Therefore, it is possible to improve the degree of freedom in selecting materials. For example, it is possible to select the optimum material for each of the seal portion 300 and the holder portion 301. For the seal portion 300, it is possible to select a material, with which it is possible to secure the sealing properties between the seal portion 300 and the cylindrical wall 27, in consideration of wear resistance, a thermal expansion coefficient, or the like, for example. For the holder portion 301, it is possible to select a material cheaper than that of the seal portion 300. Accordingly, it is possible to provide the sealing tubular member 111 at low cost while securing the sealing properties between the cylindrical wall 27 and the seal portion 300.

Hereinabove, preferred examples of the present invention have been described. However, the present invention is not limited to the above examples. Addition, omission, substitution, and other modifications of the configuration can be made without departing from the spirit of the present invention. The present invention is not limited by the above description and is limited only by the appended claims.

In a case where the sealing tubular member is provided with same-area portions on which the same pressure acts in opposite directions, the “pressure receiving urging surface” in the present specification means a portion of a pressure receiving surface excluding a region corresponding to the same-area portions, the pressure receiving surface being opposite to the valve slide contact surface.

In the above-described embodiments, a case where the valve body 22 (cylindrical wall 27) and the valve housing 21 (circumferential wall of housing main body 25) are formed in tubular shapes (of which diameter is uniform over entire area thereof in axial direction) has been described. However, the present invention is not limited to the above-described configuration. That is, as long as the cylindrical wall 27 is rotatable in the circumferential wall of the housing main body 25, the outer diameter of the cylindrical wall 27 and the inner diameter of the circumferential wall of the housing main body 25 can be changed in the axial direction. In this case, as each of the shapes of the cylindrical wall 27 and the circumferential wall of the housing main body 25, various shapes such as a spherical shape (shape of which diameter decreases toward opposite end portions from central portion in axial direction), a saddle-like shape (shape of which diameter increases toward opposite end portions from central portion in axial direction), a shape having a three-dimensional curved surface like a shape in which a plurality of spherical shapes and saddle-like shapes are aligned with each other, a tapered shape (shape of which diameter gradually increases toward second side from first side in axial direction), and a stepped shape (shape of which the diameter changes in stepwise manner toward second side from first side in axial direction) can be adopted.

In the above-described embodiments, the cylindrical wall 27 provided with opening portions on opposite sides in the axial direction has been described as an example of the hollow rotary body according to the present invention. However, the present invention is not limited to the above-described configuration. At least one side of the hollow rotary body in the axial direction may be closed as long as the hollow rotary body is rotatable in the housing main body 25 and a valve hole through which the inside and the outside of the hollow rotary body communicate with each other is formed. In this case, as the shape of the hollow rotary body, a spherical shape or a semi-spherical shape can be adopted.

In the above-described embodiments, a restriction portion for restricting the urging spring 113 from positionally deviating relative to the tubular portion 30 has been described as the tubular restriction tube 55. However, the present invention is not limited to the above-described configuration. For example, restriction portions may be formed at intervals in a circumferential direction of the tubular portion 30.

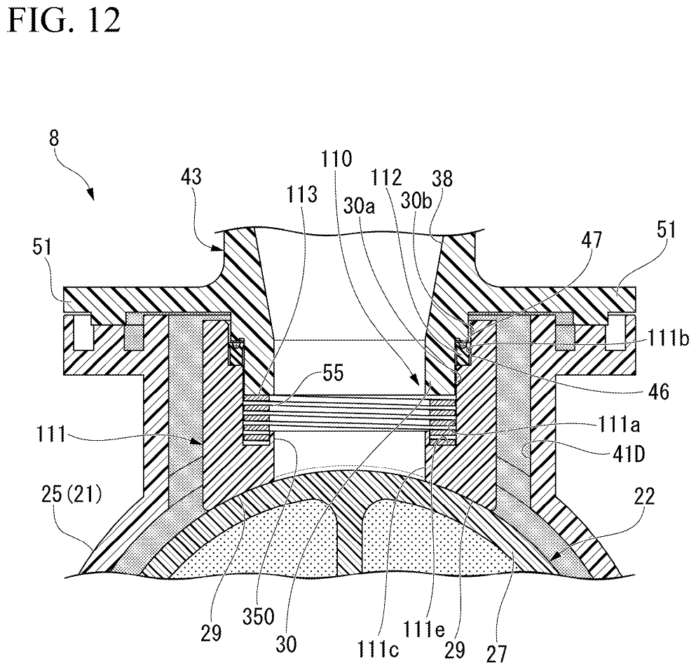

In the above-described embodiments, a case where a restriction portion (restriction tube 55) is formed on the tubular portion 30 has been described. However, the present invention is not limited to the above-described configuration. For example, as shown in FIG. 12, the sealing tubular member 111 may be provided with a restriction portion 350. Specifically, the restriction portion 350 protrudes toward a side opposite to the valve body 22 side from the second connection surface 111e. The restriction portion 350 may have a tubular shape extending over the entire circumference in the circumferential direction of the sealing tubular member 111 and may be intermittently formed in the circumferential direction.

Accordingly, it is possible to limit the positional deviation of the urging spring 113 relative to the sealing tubular member 111 in the radial direction. The restriction portion may be formed on both of the joint member 43 and the sealing tubular member 111.

In the above-described embodiments, a case where the seal ring 112 is formed of an annular elastic member having a Y-shaped section has been described. However, the present invention is not limited to the above-described configuration. As the shape of the seal ring 112 various shapes such as an annular elastic member having an O-shaped section or an X-shaped section can be adopted.

### REFERENCE SIGNS LIST

8 . . . control valve

21 . . . valve housing

22 . . . valve body

27 . . . cylindrical wall (hollow rotary body)

28A, 28C, 28D, 28E . . . valve hole

29 . . . valve slide contact surface

30 . . . tubular portion

30a . . . small-diameter outer circumferential surface

30b . . . large-diameter outer circumferential surface

30c . . . level difference surface

30d . . . end surface (second facing portion)

37 . . . inflow port

41A, 41C, 41D, 41E . . . discharge port

46 . . . seal accommodation space

47 . . . liquid pressure chamber

55 . . . restriction tube (restriction portion)

57 . . . closeness prevention groove

111 . . . sealing tubular member

111a . . . medium-diameter inner circumferential surface

111b . . . large-diameter inner circumferential surface

111c . . . small-diameter inner circumferential surface

111d . . . first connection surface (first facing portion)

111e . . . second connection surface (second facing portion)

112 . . . seal ring

113 . . . urging spring

202a . . . pressure receiving urging surface

220 . . . accommodation groove

300 . . . restriction portion

311a . . . pressure receiving urging surface

1. A control valve comprising:
a valve housing that is provided with an inflow port through which liquid flows into the valve housing from an outside and a discharge port through which the liquid flowing into the valve housing is discharged to the outside;
a joint member connected to the discharge port;
a valve body that is rotatably disposed in the valve housing and is provided with a hollow rotary body in which a valve hole, through which an inside and an outside of the hollow rotary body communicate with each other, is formed; and
a sealing tubular member that is provided with a valve slide contact surface, which slidably abuts an outer surface of the hollow rotary body at a position at which at least a portion of the valve slide contact surface overlaps a rotation route of the valve hole of the valve body, and that connects the joint member and the valve body to each other inside the discharge port,
wherein the valve body allows liquid to flow out to the discharge port from a region inside the hollow rotary body when the valve body is at a rotation position at which the valve hole and the sealing tubular member communicate with each other and the valve body controls or blocks the liquid flowing out to the discharge port from the region inside the hollow rotary body when the valve body is at a rotation position at which the valve hole and the sealing tubular member do not communicate with each other,
wherein the joint member is provided with a tubular portion that is disposed inward of the sealing tubular member and slidably holds an inner circumferential surface of the sealing tubular member via a seal ring,
wherein the joint member and the sealing tubular member are provided with
first facing portions that face each other in an axial direction of the sealing tubular member, and
second facing portions that face each other in the axial direction while being disposed inward of the first facing portions in a radial direction of the sealing tubular member, and
wherein the second facing portions are provided with an urging spring that is interposed between the joint member and the sealing tubular member and that urges the sealing tubular member toward the valve body.

2. The control valve according to claim 1,
wherein a surface of the sealing tubular member, which faces the joint member and which is one of the first facing portions, constitutes a pressure receiving urging surface that receives a pressure of liquid in the valve housing and generate a pressing force in a direction toward the valve body, and
wherein an area of the valve slide contact surface is set to be larger than an area of the pressure receiving urging surface.

3. The control valve according to claim 1,
wherein the tubular portion is provided with a small-diameter outer circumferential surface, a large-diameter outer circumferential surface that is formed to be increased in diameter in a stepped shape from an end portion of the small-diameter outer circumferential surface that is separate from the valve body, and a level difference surface that connects the small-diameter outer circumferential surface and the large-diameter outer circumferential surface to each other,
wherein the sealing tubular member is provided with
a medium-diameter inner circumferential surface that is slidably fitted onto the small-diameter outer circumferential surface of the joint member,
a large-diameter nner circumferential surface that is formed to be increased in diameter in a stepped shape from an end portion of the medium-diameter inner circumferential surface that is separate from the valve body,
a first connection surface that connects the medium-diameter inner circumferent al surface and the large-diameter inner circumferential surface to each other,
a small-diameter inner circumferential surface that is formed to be decreased in diameter in a stepped shape from an end portion of the medium-diameter inner circumferential surface that is close to the valve body, and
a second connection surface that connects the medium-diameter inner circumferential surface and the small-diameter Inner circumferential surface to each other,
wherein an annular seal accommodation space surrounded by the small-diameter outer circumferential surface and the large-diameter inner circumferential surface is provided between the level difference surface of the joint member and the first connection surface of the sealing tubular member,
wherein the seal ring is in close contact with the small-diameter outer circumferential surface and the large-diameter inner circumferential surface inside the seal accommodation space, and
wherein the urging spring is provided between the second connection surface and the tubular portion in the second facing portions.

4. The control valve according to claim 3,
wherein a liquid pressure chamber into which a pressure of liquid in the valve housing is introduced is formed between the level difference surface of the joint member and the seal ring, and
wherein a closeness prevention groove through which the liquid pressure chamber and an outside of the liquid pressure chamber communicate with each other is formed in the level difference surface of the joint member.

5. The control valve according to claim 1,
wherein an annular accommodation groove in which the seal ring is accommodated is formed in an outer circumferential surface of the tubular portion.

6. The control valve according to claim 1,
wherein a restriction portion that protrudes in the axial direction from at least one of the joint member and the sealing tubular member and that holds the urging spring in the radial direction is formed in a portion of the second facing portions that is positioned radially inward of the urging spring.

7. The control valve according to claim 2,
wherein the tubular portion is provided with a small-diameter outer circumferential surface, a large-diameter outer circumferential surface that is formed to be increased in diameter in a stepped shape from an end portion of the small-diameter outer circumferential surface that is separate from t he valve body, and a level difference surface that connects the small-diameter outer circumferential surface and the large-diameter outer circumferential surface to each other,
wherein the sealing tubular member is provided with
a medium-diameter inner circumferential surface that is slidably fitted onto the small-diameter outer circumferential surface of the joint member,
a large-diameter inner circumferential surface that is formed to be increased in diameter in a stepped shape from an end portion of the medium-diameter inner circumferential surface that is separate from the valve body,
a first connection surface that connects the medium-diameter inner circumferential surface and the large-diameter inner circumferential surface to each other,
a small-diameter inner circumferential surface that is formed to be decreased in diameter in a stepped shape from an end portion of the medium diameter inner circumferential surface that is close to the valve body, and
a second connection surface that connects the medium-diameter inner circumferential surface and the small-diameter inner circumferential surface to each other,
wherein an annular seal accommodation space surrounded by the small-diameter outer circumferential surface and the large-diameter inner circumferential surface is provided between the level difference surface of the joint member and the first connection surface of the sealing tubular member,
wherein the seal ring is in close contact with the small-diameter outer circumferential surface and the large-diameter inner circumferential surface inside the seal accommodation space, and
wherein the urging spring is provided between the second connection surface and the tubular portion in the second facing portions.

8. The control valve according to claim 7,
wherein a liquid pressure chamber into which a pressure of liquid in the valve housing is introduced is formed between the level difference surface of the joint member and the seal ring, and
wherein a closeness prevention groove through which the liquid pressure chamber and an outside of the liquid pressure chamber communicate with each other is formed in the level difference surface of the joint member.

9. The control valve according to claim 2,
wherein an annular accommodation groove in which the seal ring is accommodated is formed in an outer circumferential surface of the tubular portion.

10. The con of valve according to claim 2,
wherein a restriction portion that protrude in the axial direction from at least one of the joint member and the sealing tubular member and that holds the urging spring in the radial direction is formed in a portion of the second facing portions that is positioned radially inward of the urging spring.

11. The control valve according to claim 3,
wherein a restriction portion that protrudes in the axial direction from at least one of the joint member and the sealing tubular member and that holds the urging spring in the radial direction is formed in a portion of the second facing portions that is positioned rad ally inward of the urging spring.

12. The control valve according to claim 4,
wherein a restriction portion that protrudes in the axial direction from at least one of the joint member and the sealing tubular member and that holds the urging spring in the radial direction is formed in a portion of the second facing portions that is positioned radially inward of the urging spring.

13. The control valve according to claim 5,
wherein a restriction portion that protrudes in the axial direction from at least one of the joint member and the sealing tubular member and that holds the urging spring in the radial direction is formed in a portion of the second facing portions that is positioned radially inward of the urging spring.

14. The control valve according to claim 7,
wherein a restriction portion that protrude in the axial direction from at least one of the joint member and the sealing tubular member and that holds the urging spring in the radial direction is formed in a portion of the second facing portions that is positioned radially inward of the urging spring.

15. The control valve according to claim 8,
wherein a restriction portion that protrudes in the axial direction from at least one of the joint member and the sealing tubular member and that holds the urging spring in the radial direction is formed in a portion of the second facing portions that is positioned radially inward of the urging spring.

16. The control valve according to claim 9,
wherein a restriction portion that protrudes in the axial direction from at least one of the joint member and the sealing tubular member and that holds the urging spring in the radial direction is formed in a portion of the second facing portions that is positioned radially inward of the urging spring.
